(19) United States
(12) Patent Application Publication
(10) Pub. No.: US 2026/0155342 A1
(43) Pub. Date: Jun. 4, 2026

(54) METHOD FOR AVERAGING AND ION ACCUMULATION

(71) Applicant: Thermo Fisher Scientific (Bremen) GmbH, Bremen (DE)

(72) Inventor: Hamish Stewart, Bremen (DE)

(21) Appl. No.: 19/398,676

(22) Filed: Nov. 24, 2025

(30) Foreign Application Priority Data
Nov. 29, 2024 (GB) 2417606.7

(51) Int. Cl. H01J 49/00; H01J 49/04; H01J 49/40; H01J 49/42

(52) U.S. Cl. CPC H01J 49/0031; H01J 49/004; H01J 49/0431; H01J 49/406; H01J 49/4265; H01J 49/4295

(57) ABSTRACT

A method of operating an analytical instrument for analysing ions is provided. The analytical instrument comprises an ion storage device. The method comprises determining a target accumulation time and determining whether the target accumulation time is greater than or less than a threshold accumulation time. Based on the target accumulation time being greater than or less than the threshold accumulation time. ions are accumulated in the ion storage device and injected as one or more pulses for analysis. The method further comprises performing an analysis on each of the one or more injected pulses. An analytical instrument for analysing ions is also provided.

### CROSS REFERENCE TO RELATED APPLICATIONS

This application is a U.S. non-provisional application which claims the benefit of priority under 35 U.S.C. § 119(a) to United Kingdom Patent Application No. GB2417606.7, which was filed on November 29, 2024 and which is hereby incorporated by reference in its entirety into this specification.

### Technical Field

The present disclosure relates to the field of mass spectrometry, particularly methods of mass spectrometry in which ions are accumulated in an ion trap.

### Background

Many mass analysers operate in a pulsed fashion, accumulating ions from a continuous source prior to analysis. Because of this concentration of ions, such analysers are particularly vulnerable to the effects of space charge, where mutual repulsion between large numbers of ions begins to overwhelm the directed forces applied by the mass analyser. The space charge effects may be detrimental to the dynamic range of the mass analyser.

The accumulation times required for useful mass spectra greatly vary depending on the ions to be analysed. Too little accumulation time can result in the trap being underfilled and the spectrum being wasted. Too much accumulation time, on the other hand, may cause saturation effects and/or exceed the repetition period of the analyser, leading to a reduction in the rate at which different analytes can be studied.

Mass analysers with accumulating traps typically use automatic gain control, or AGC, methods to determine the ion current or population in a pre-scan and subsequently determine the appropriate accumulation time. Some mass analysers may use predictive AGC where a full mass scan over a broad mass range is used to determine accumulation times for ion fragmentation scans.

Current mass analysers without accumulating traps, such as orthogonal time-of-flight instruments, can have very high repetition rates and can vary the measurement time for different numbers of ions and may repeat scans and dynamically control when and how many averages are taken.

Ion trap time-of-flight (IT-ToF) mass analysers accumulate ions in an ion trap and eject these ions in pulsed ion packets for mass analysis. The ion trap may accumulate ions over a controlled ion accumulation time depending on the accumulation time required for a useful mass spectrum for a particular precursor ion. Low intensity precursors might have an accumulation time significantly higher than the repetition period of the IT-ToF mass analyser. This means that there is downtime in the analyser between subsequent analyses in the ToF mass analyser when the accumulation time exceeds the time it takes for an ion fragmentation scan.

Therefore, there remains a need for an improved method of controlling mass analysers with accumulating traps that can provide improved efficiency and improved dynamic range.

### Summary

In summary there is provided a method of operating an analytical instrument for analysing ions, wherein the analytical instrument comprises an ion storage device, the method comprising: determining a target accumulation time (i.e., the desired accumulation time); determining whether the target accumulation time is greater than a threshold accumulation time; when it is determined that the target accumulation time is less than the threshold accumulation time: accumulating ions in the ion storage device over the target accumulation time; and injecting the accumulated ions as a pulse for analysis; when it is determined that the target accumulation time is greater than the threshold accumulation time: defining a plurality of shorter accumulation times, the shorter accumulation times each being shorter than the target accumulation time, the shorter accumulation times being determined based on the target accumulation time and the threshold accumulation time; and sequentially for each of the shorter ion accumulation times: accumulating ions in the ion storage device over the shorter ion accumulation time and injecting the ions accumulated over the shorter ion accumulation time as a pulse for analysis; and performing analysis of the/each injected pulse.

Advantageously, such a method can provide improved efficiency and improved dynamic range.

The instrument comprises a downstream mass analyser downstream of the ion storage device, and the step of performing analysis of the/each injected pulse comprises analysing the/each pulse using the downstream mass analyser. The method is advantageously applied to analysis using a mass analyser, such as a time of flight mass analyser or a multiple reflection time of flight mass analyser.

The ion storage device may comprise an ion extraction trap. In some embodiments, the step of injecting the accumulated ions as a pulse may comprise extracting the accumulated ions as a pulse from the extraction trap.

Optionally, the ion storage device may also comprise other ion storage devices for accumulating ions. These other ion storage devices may be, for example, upstream of the extraction trap.

Optionally, ions are accumulated in the ion storage device/extraction trap during the step of performing analysis of the/each injected pulse. This can improve the time efficiency of the analytical instrument.

For improved efficiency and dynamic range, the threshold accumulation time can be determined based on a number of parameters including those set out below.

Optionally, the threshold accumulation time is based at least in part on the time needed for a single analysis of a pulse using the downstream mass analyser.

The method may comprise separating sample molecules in a liquid chromatograph, in which case, the threshold accumulation time may be based at least in part on the resolution of the liquid chromatograph.

The analytical instrument may comprise an ion source upstream of the ion storage device/extraction trap and one or more ion optical devices arranged between the ion source and the ion storage device/extraction trap, with the threshold accumulation time being based at least in part on the overhead time for ions to pass through the one or more ion optical devices.

The threshold accumulation time may be based at least in part on the space charge limit of the ion storage device/extraction trap and/or the space charge limit of the downstream mass analyser.

Performing analysis each injected pulse may produce a result, i.e. mass spectrometric data such as a mass spectrum. When it is determined that the target accumulation time is greater than the threshold accumulation time, the method may involve taking an average, sum or weighted sum of the results of the steps of performing analysis of each injected pulse.

The method optionally comprises limiting the number of shorter accumulation times based on a predetermined maximum number. It may be that certain precursor ions are provided in very low quantities (i.e., merely trace levels) and could potentially dominate the time taken to operate the analytical instrument.

The plurality of shorter accumulation times may be equal or may be unequal. Thus, there is flexibility in determining the accumulation times.

The step of performing analysis of the/each injected pulse may be performed using one or more parameter(s) for the instrument, where the one or more parameters can include, for example: fragmentation energy (e.g. collision energy in the case of collision induced dissociation (CID)), an amplitude and/or frequency of an applied RF voltage (e.g. of a trapping voltage applied to the ion storage device), a gain of an ion detector of the mass analyser, and so on. Optionally, when it is determined that the target accumulation time is greater than the threshold accumulation time, the method comprises modifying one or more of the parameter(s) between each injected pulse, i.e. so that each injected pulse is analysed using one or more different parameter(s). This can enable analysis parameters to be tuned or a range of different analysis parameters to be used. For example, different collision energies allow differing fragmentation properties at cost of time, and so the additional scans may provide richer feature information. Similarly, variation of RF amplitude and/or frequency applied to the ion storage device allows an enhancement of the achievable mass range over multiple scans, while changing detector gain may expand dynamic range.

In some embodiments the ion extraction trap is a radio frequency voltage ion extraction trap, comprising electrodes for extracting ions from the ion extraction trap by the application of a DC voltage. The method is particularly applicable to an analytical instrument with such an ion extraction trap, since the method can reduce or avoid space charge effects that can occur in such ion extraction traps.

The target accumulation time may be determined by analysing a sample of ions, e.g. where the sample of ions is representative of the ions that are to be analysed by the downstream mass analyser. The sample of ions may be analysed by a mass analyser or some other ion analyser, e.g. an electrometer.

Where a mass analyser is used, the mass analyser used to analyse the sample of ions to determine the target accumulation time may be the downstream mass analyser or may be a second mass analyser, that is a different component from the downstream mass analyser. The second mass analyser is optionally an electrostatic orbital trapping mass analyser such as an Orbitrap^{TM} mass analyser.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

### Brief Description of the Drawings

For a better understanding of the disclosure, and to show how the same may be put into effect, reference will now be made, by way of example only, to the accompanying drawings, in which:

FIG. 1 shows a schematic arrangement of a mass spectrometer suitable for carrying out methods in accordance with embodiments of the disclosure;

FIG. 2 shows three graphs depicting problems in the prior art which may be caused by the overfilling of ion traps;

FIG. 3 illustrates a known method of operating the mass spectrometer of FIG. 1;

FIG. 4 illustrates a method of operating a mass spectrometer in accordance with the disclosure;

FIG. 5 illustrates a method of operating a mass spectrometer in accordance with the disclosure;

FIG. 6 illustrates a method of operating a mass spectrometer in accordance with the disclosure;

FIG. 7 shows a schematic arrangement of a mass spectrometer suitable for carrying out methods in accordance with embodiments of the disclosure; and

FIG. 8 illustrates a method of operating a mass spectrometer in accordance with the disclosure.

### Detailed Description

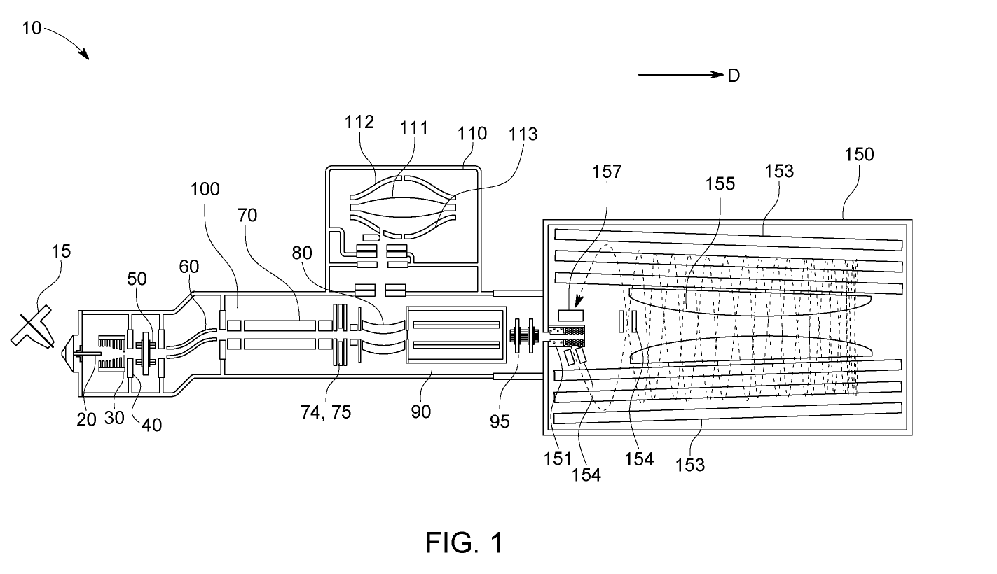

FIG. 1 shows a schematic arrangement of a mass spectrometer that may be operated in accordance with embodiments of the present disclosure. It will be understood that the instrument shown in FIG. 1 is a non-limiting example, and that numerous variations are possible.

The instrument of FIG. 1 comprises an ion source 15, ion transfer stages 100, an initial mass analyser 110, an extraction trap 151, and a downstream mass analyser 150.

The ion source 15 is configured to generate ions from a sample. The ion source 15 can be a continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. More than one ion source may be provided and used. The ions may be, e.g. small and large organic molecules, biomolecules, DNA, RNA, proteins, peptides, fragments thereof and the like.

The ion source 15 may be coupled to a separation device such as a liquid chromatography separation device or a capillary electrophoresis separation device (not shown), such that the sample which is ionised in the ion source 15 comes from the separation device.

The ion transfer stages 100 may be positioned downstream of the ion source 15 and upstream of the extraction trap 151. The ion transfer stages 100 may comprise a capillary 20, an ion funnel 30, a calibrant source 40, a quadrupole pre-filter 50, an ion guide 60, a quadrupole mass filter 70, a charge detector 75, a curved linear ion trap (C-trap) 80, a collision cell 90, and a multipole ion guide 95. The ion guide 60 may be of the design described in US patent No. 9,536,722.

Ions from the ion source may be accumulated in the C-trap 80 and/or the collision cell 90 by opening and closing an ion gate 74 located within the charge detector 75. The charge detector 75 may be positioned between quadrupole mass filter 70 and the C-trap 80.

Optionally, the initial mass analyser 110 is an electrostatic orbital trap mass analyser. An example of such a mass analyser is the Orbitrap® mass analyser sold by Thermo Fisher Scientific, Inc. As shown in FIG. 1, the initial mass analyser 110 may comprise an inner electrode 111 elongated along the orbital trap axis and a split pair of outer electrodes 112, 113 which surround the inner electrode 111 and define therebetween a trapping volume in which ions are trapped and oscillate by orbiting around the inner electrode 111, to which is applied a trapping voltage, whilst oscillating back and forth along the axis of the trap. The pair of outer electrodes 112, 113 function as detection electrodes to detect an image current induced by the oscillation of the ions in the trapping volume and thereby provide a detected signal.

The outer electrodes 112, 113 typically function as a differential pair of detection electrodes and are coupled to respective inputs of a differential amplifier (not shown in FIG. 1), which in turn forms part of a digital data acquisition system to receive the detected signal. The detected signal can be processed using Fourier transformation to obtain a first mass spectrum of ions within the initial mass analyser 110.

Once accumulated in the ion trap 80 and/or collision cell 90, ions can be injected into the initial mass analyser 110. To do this, the ions may be ejected from the trap 80 in a direction orthogonal to the axis of the trap (orthogonal ejection), for example, by applying one or more suitable DC voltages to the ion trap 80. The ions may be injected into the mass analyser 110 via one or more lenses and a deflector electrode.

Optionally, the downstream mass analyser 150 is an ion trap time-of-flight (IT-ToF) mass analyser. An example of such a mass analyser is the Astral® mass analyser sold by Thermo Fisher Scientific, Inc. The IT-ToF mass analyser may be a multiple reflection time-of-flight mass analyser (mr-ToF), e.g. as described in US patent no. 9,136,101. The mr-ToF mass analyser 150 is constructed around two opposing ion mirrors 153, elongated in a drift direction D. The mirrors are opposed in a direction that is orthogonal to the drift direction. The extraction trap 151 injects ions into a first mirror of the two mirrors 153 and the ions then oscillate between the two mirrors 153. The angle of ejection of ions from the extraction trap 151 and additional deflectors 154 allow control of the energy of the ions in the drift direction, such that ions are directed down the length of the mirrors 153 as they oscillate, producing a zig-zag trajectory. The mirrors 153 themselves are tilted relative to one another, producing a potential gradient that retards the ions' drift velocity and causes them to be reflected back in the drift dimension and focused onto a detector 157. The tilting of the opposing mirrors would normally have the negative side-effect of changing the time period of ion oscillations as they travel down the drift dimension. This can be corrected using a stripe electrode 155 (to act as a compensation electrode) that alters the flight potential for a portion of the inter-mirror space, varying down the length of the opposing mirrors 153. The combination of the varying width of the stripe electrode 155 and variation of the distance between the mirrors 153 allows the reflection and spatial focusing of ions onto the detector 157 as well as maintaining a good time focus.

The downstream mass analyser 150 is configured to operate with a repetition period T_{R}. During each repetition period, a packet of ions is mass analysed by the mass analyser, and at the same time a new packet of ions is accumulated in the extraction trap 151. The repetition period T_{R} of the downstream mass analyser 150 may be defined primarily by the time taken for an ion packet to be accumulated in the extraction trap 151 and ejected into the mass analyser. Furthermore, it may be necessary to operate the ejection trap 151 in a non-accumulating mode for some minimum amount of time during each repetition period (e.g. to allow time for accumulated ions to be processed, etc.). The repetition period should, of course, also be long enough to allow each packet of ions to be mass analysed (i.e. to allow the ions to traverse the mass analyser, reach the detector 157, and for the data to be analysed for a mass spectrum to be produced), but the mass analysis of a packet of ions typically requires less time than is needed for its accumulation.

In some embodiments, the downstream analyser 150 has a repetition period of 5 ms or less. The repetition period is the inverse of the repetition rate, which is the number of mass spectra acquired by the downstream analyser 150 per second. In some embodiments, the downstream analyser 150 has a repetition rate of 200 Hz or more.

The extraction trap 151 may be an ion processor as described in US patent no. 9,548,195. The extraction trap 151 is provided to form an ion packet of ions prior to injection into the ToF mass analyser 150. The extraction trap 151 accumulates ions over an accumulation time, allowing the continuous beam of ions from the ion source to be transformed into a concentrated ion packet. The accumulation time may be controlled by the ion gate 74. The ion gate 74 may be located in the charge detector assembly 75. After the accumulation time has elapsed, the accumulated ion packet is ejected as a pulse from the extraction trap 151 into the ToF mass analyser 150. The ejection may occur significantly quickly such that it much shorter than the accumulation time.

The extraction trap 151 may contain a buffer gas and incorporate two trapping regions, a first region at a first pressure for rapid ion cooling, and a second region at a second pressure for ion extraction. The first pressure is higher than the second pressure. Ions are cooled in the high-pressure first region and then transferred to the low-pressure second region, where they are pulse ejected into the ToF analyser. The pulse ejection may involve applying a DC voltage to the extraction trap 151.

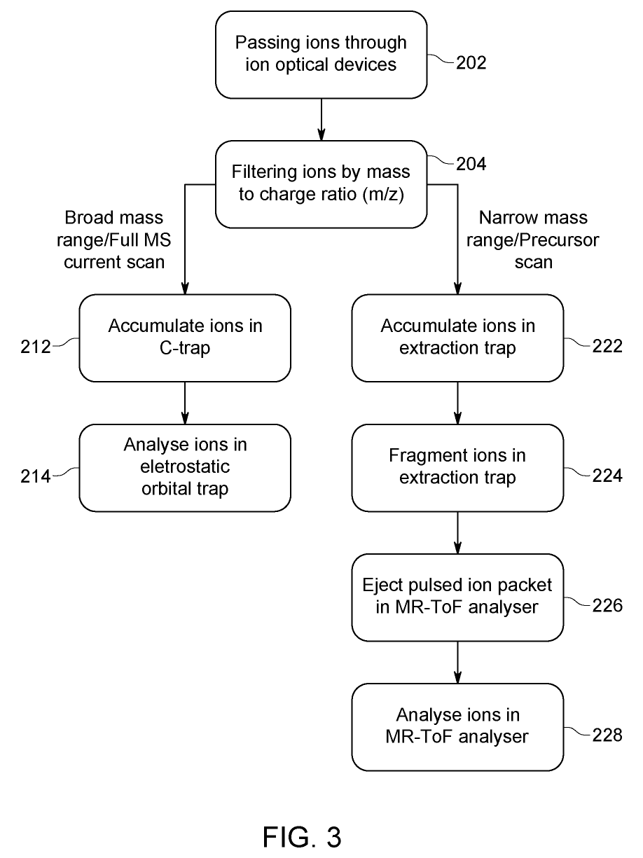

FIG. 3 illustrates a method of performing an analysis of a sample using an instrument such as that shown in FIG. 1. The method may involve firstly carrying out an MS1 (e.g., a full mass scan) in the initial mass analyser 110, and then carrying out an MS2 scan in the downstream mass analyser 150. The MS1 scan provides a measurement of the ions (optionally filtered by mass to charge ratio (m/z)) provided from the ion source 15 (i.e., an MS1 spectrum).

During the MS2 scan, the instrument filters the ions supplied from the ion source 15 to provide a range of precursors filtered by mass to charge ratio (m/z). The filtered precursors are fragmented, and the resulting fragment ions are analysed in the downstream mass analyser 150 to provide a measurement of the ions (i.e., an MS2 spectrum).

In step 202, ions are passed through various ion transfer stages 100, such as those in FIG. 1. Among these are mass filters, such as the quadrupole pre-filter 50 and the quadrupole filter 70. The ions are passed through the mass filter and filtered by mass to charge ratio (m/z) (step 204). When completing an MS1 scan, the range of ion masses allowed through the quadrupole filter 70 is generally broader than that of an MS2 scan.

When completing an MS1 scan, the ions are accumulated and cooled in the C-trap 80 in step 212, and then ejected orthogonally into the electrostatic orbital trap or Orbitrap^{TM} mass analyser 110 for analysis in step 214. The Orbitrap^{TM} mass analyser MS1 scan may take a few hundred ms, such as approximately 250 ms.

When completing an MS2 scan, the ions pass through the C-trap 80 and then pass through a multipole ion guide 95 and into the extraction trap 151 where they are accumulated in step 222. In step 224, ions are fragmented in the high pressure region of the extraction trap 151. The ions accumulate in the extraction trap 151 for a time determined by an ion gate 75 upstream of the trap, for example, the ion gate 75 may be within a charge detector 74 positioned between the quadrupole filter 70 and the C-trap 80. The accumulated ions are ejected as a pulse from the extraction trap 151 into the ToF mass analyser 150 by applying extraction voltages to electrodes of the extraction trap 151 in step 226. The ion packet is then analysed in the downstream analyser 150 in step 228.

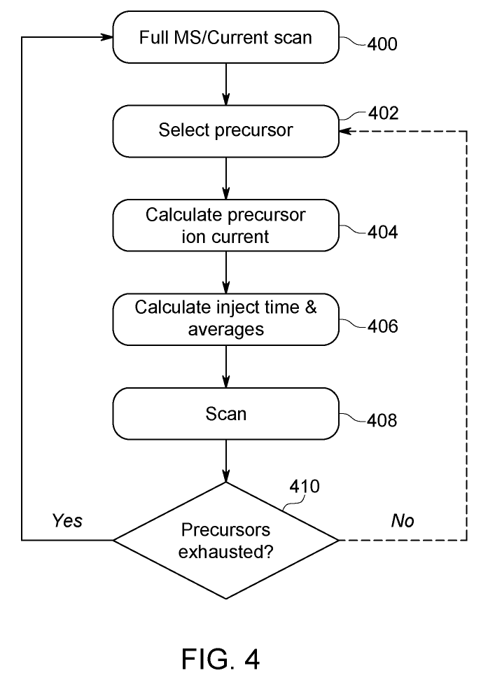

FIG. 4 illustrates a method incorporating AGC methods and dynamic averaging in accordance with the present disclosure. As shown in FIG. 4, an initial scan (such as an MS1 scan or full mass scan), is taken from which ion current information for AGC may be acquired in step 400. Optionally, the initial scan is carried out by the initial mass analyser 110.

In data dependent acquisition, the initial scan may be used to provide measurement information about precursor ions. For example, the initial scan may be used to provide a list of precursor ions. A precursor ion to be analysed may be selected from the list (step 402). Using the information from the initial scan, the ion current for the precursor ion may be calculated (step 404). Based on this, the desired accumulation time T_{D} may be calculated, and based on the desired accumulation time T_{D}, whether averages are to be taken and how many may be determined (step 406).

An MS2 scan is then carried out (step 408) to produce a fragment mass spectrum, and a check may be made if there are remaining precursor ions to be analysed at which point the next precursor ion in the list is selected and an MS2 scan is performed for that precursor ion, or the instrument moved on to the next MS1 scan (step 410). Optionally, each MS2 scan 408 is carried out by the downstream mass analyser 150.

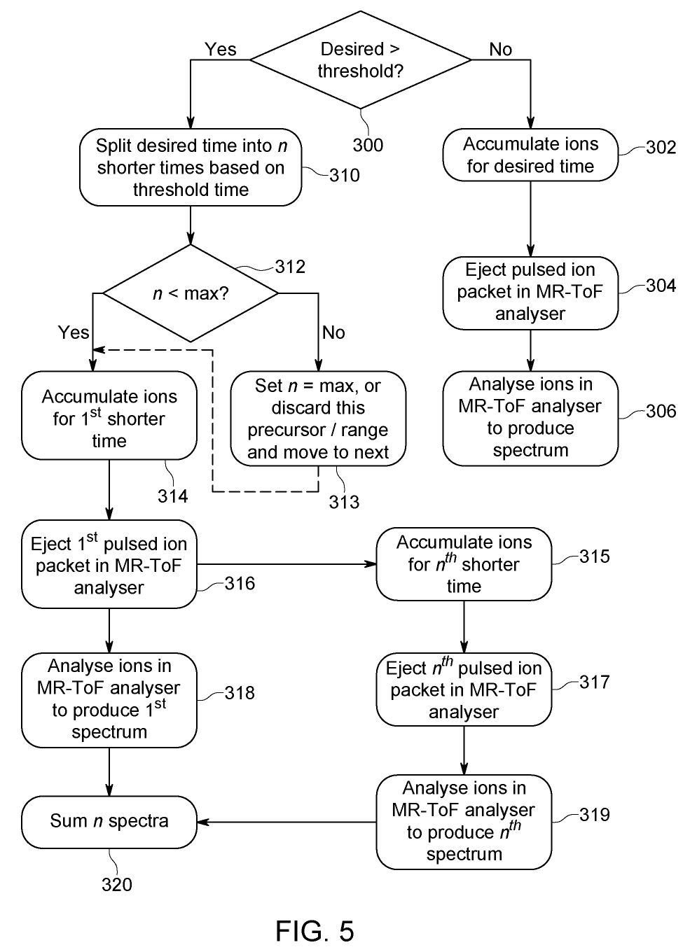

FIG. 5 illustrates a method of dynamically determining whether averages should be taken in a mass analyser according to embodiments of the present disclosure. As shown in FIG. 5, a desired accumulation time T_{D} is compared to a threshold accumulation time T_{T} for the ion trap (step 300), and it is determined whether or not the desired accumulation time T_{D} is greater than the threshold accumulation time T_{T}.

The threshold accumulation time may be based on a variety of factors, including but not limited to any combination of: the repetition period T_{R} of the downstream mass analyser 150, a timing overhead T_{O}, or the space charge capacity limit of the extraction trap 151 (and/or of the mass analyser 150).

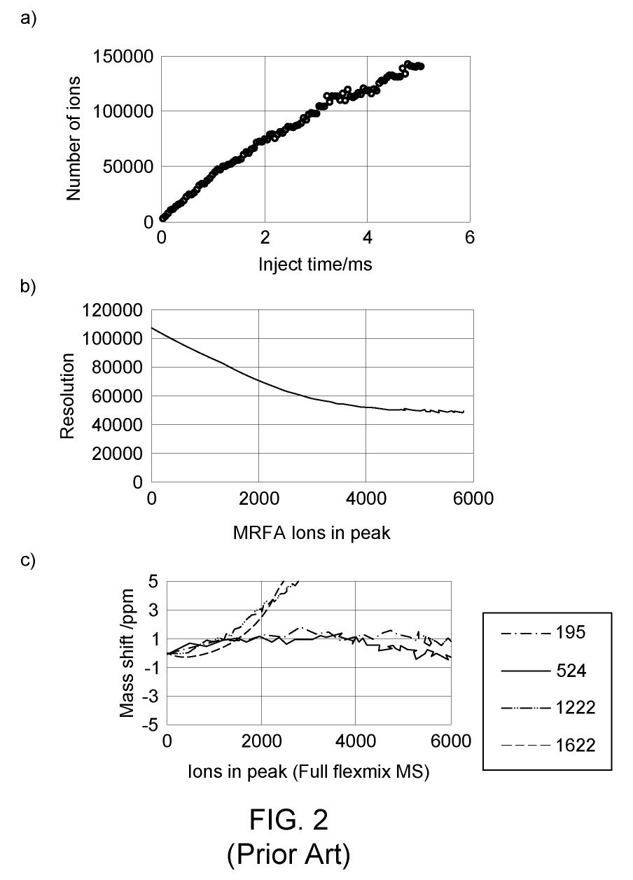

The space charge capacity limit of the extraction trap 151 is the limit to how much the trap 151 can be filled before the linear relationship between the number of ions and the fill time breaks down. Above the space charge capacity, there can also be a negative impact on the resolution of the resulting spectrum, and an increased mass shift of high m/z ions. These effects are shown in FIG. 2.

To avoid increasing the repetition rate, the timing overhead T_{O} can be used for determining the threshold accumulation time T_{T}.

The timing overhead T_{O} is the time required between fills of the extraction trap 151, e.g. due to the need for the ions to pass from the source 15 through the ion transfer stages 100 to the extraction trap 151, for the accumulated ions to be processed, etc.

In some embodiments, pre-accumulation can be used to, in effect, reduce the timing overhead T_{O}, with the ions for the next analysis being accumulated in one of the ion transfer stages 100 upstream of the extraction trap 151 during times when the extraction trap 151 cannot be directly filled. In embodiments in which results of one scan are to influence the parameters of the next scan, the necessary computation time can contribute to the timing overhead T_{O.}

The threshold accumulation time T_{T} may also or instead be based on the peak width of the ion from the liquid chromatograph if used to separate the sample molecules.

In some embodiments, narrower peak widths from the liquid chromatograph can correspond to higher intensity peaks and so shorter injection times, while wider peak widths can correspond to smaller intensity peaks and so longer injection times. For example, the threshold accumulation time T_{T} may be decreased for narrower peak widths. Conversely, the threshold accumulation time T_{T} may be increased for wider peak widths. Optionally, the number of shorter accumulation times can also be limited based on the peak width. For example, larger peak widths may lead to an increased limit on the number of shorter accumulation times (as there will be more time to allow for more scans). Smaller peak widths may lead to a reduced limit on the number of shorter accumulation times (as there will be less time for the multiple scans).

The desired accumulation time T_{D} may be determined based on automatic gain control (AGC) methods known to those skilled in the art, such that the desired accumulation time T_{D} fills or would fill the extraction trap with the number of ions required for a comprehensive analysis of the sample. The desired accumulation time T_{D} ensures or would ensure that each packet of ions has at least the desired minimum number of ions, such that the resulting ion packet arriving at the detector 157 will be representative of the entire mass range of interest for the selected precursor ion.

If the desired accumulation time T_{D} is less than or equal to the threshold accumulation time T_{T}, then ions are accumulated in the extraction trap 151 for the desired accumulation time T_{D} (step 302) before being ejected as a single pulse into the downstream mass analyser 150 (step 304) and analysed to produce a mass spectrum (step 306), without modification to the method of FIG. 3.

If the desired accumulation time T_{D} is greater than the threshold accumulation time T_{T}, then the desired accumulation time T_{D} is split into a plurality of n shorter accumulation times, T₁ to T_{N}, based on the threshold accumulation time T_{T} (step 310). The n shorter times may be of equal duration, or they may be of unequal duration. If the n times are of unequal duration, the resulting n mass spectra may have a variety of gain levels. The number of n shorter times may be determined by dividing the desired accumulation time T_{D} by the threshold accumulation time T_{T} and rounding up to the nearest whole number. The duration of the n shorter times may be determined by dividing the desired accumulation time T_{D} by the number of shorter times n, or they may be equal to the threshold accumulation time T_{T}, or they may be a mix of different durations selected through different methods. The sum of the durations of the n shorter accumulation times T₁ to T_{N} may be greater than, less than or equal to the desired accumulation time T_{D}.

_{[0072]}Optionally, sum of the durations of the n shorter accumulation times T₁ to T_{N} may be greater than the desired accumulation time T_{D} by no more than 10%. Optionally, sum of the durations of the n shorter accumulation times T₁ to T_{N} may be less than the desired accumulation time T_{D} by no more than 10%.

n may be compared to a maximum value of n (step 312). The maximum value of n may be selected such that very trace precursors which may have a very long desired accumulation time T_{D} do not dominate instrument time. Accordingly, when n is greater than the maximum value, n may be set to the maximum value, or the instrument may skip over the very trace precursor and move to the next (step 313).

Ions are accumulated in the extraction trap 151 for the first shorter accumulation time T₁ (step 314) before being pulse ejected into the ToF analyser (step 316). While the first ion packet is being analysed in the ToF analyser, the second ion packet is accumulated in the extraction trap 151 for second shorter accumulation time T₂ (step 315) and is then pulse ejected into the ToF analyser (step 317), and so on until n ion packets have been accumulated for n accumulation times and ejected and analysed (steps 318, 319).

The resulting n mass spectra are then processed to a single mass spectrum (step 320). This may be done by summing the n mass spectra or averaging the n mass spectra. The resulting mass spectrum can have improved dynamic range over a mass spectrum taken over a single ion packet accumulated over the original desired accumulation time T_{D}.

The method may involve modifying a parameter or parameters of the instrument between any of the n ejections. The parameters which may be modified may be, for example, the collision energy and/or the ion trap RF amplitude.

In some embodiments, the method may involve analysing the first of the n ion packets prior to the subsequent n-1 ion packets. This may allow for the checking for saturation effects of the trap, checking for space charged peaks, for identifying the output prior to the subsequent ejections which improve quantitation and confidence of the identified output. Optionally, the first ion packet and the resulting mass spectrum may not be included in the sum or average mass spectrum, if the parameters of the instrument or scan are changed from the subsequent n-1 ejection after the first ejection.

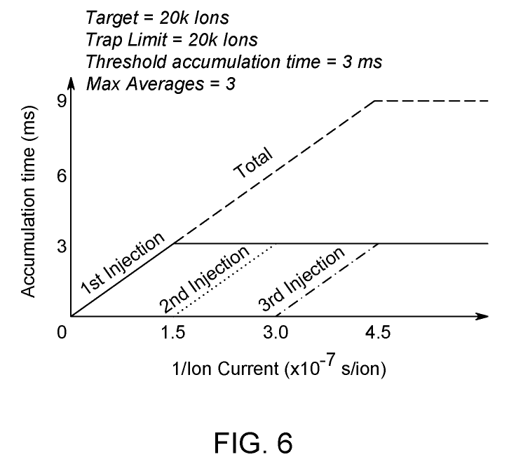

FIG. 6 shows the division of the total desired accumulation time T_{D} into n shorter accumulation times where n is 3. In the example shown in FIG. 6, the desired accumulation time T_{D} is 9 ms and the threshold accumulation time is 3 ms. In the example of FIG. 6, the n shorter times are of equal length. By splitting the desired accumulation time as shown, the total accumulation time is the same or greater than the desired accumulation time T_{D}, but more efficient use is made of the analysis instrument, and overfilling of the extraction trap is avoided.

The method of dynamically determining whether to divide the accumulation time into averages is applied in this example to an ion trap time of flight mass analyser, however, it may be applied to alternative mass analysers, including but not limited to analytical ion traps and Fourier transform analysers.

Whereas FIG. 1 involves the use of an ion extraction trap 151, in fact the method and apparatus can, more generally, use any form of ion storage device in place of the ion extraction trap 151, such as: an ion trap (more generally); an ion accumulation device; an ion trapping region; an analytical ion trap; an orthogonal accelerator; a fragmentation cell; a reaction cell and/or collision cell, or any combination thereof.

In some embodiments, ions could be accumulated in one or more ion storage devices upstream of an extraction trap (or equivalent) for injection into the analyser.

In some embodiments, ions may be accumulated in both an extraction trap and in an ion storage device upstream of the extraction trap, e.g. by pre-accumulating ions in the upstream ion storage device, transferring the pre-accumulated ions from the upstream ion storage device to the extraction trap, and then accumulating additional ions in the extraction trap. In these embodiments, the accumulation time may correspond to the sum of the pre-accumulation time in the upstream ion storage device and the additional accumulation time in the extraction trap.

In some embodiments, the ion storage device is a region, such as a trapping region (e.g. an accumulation region), of an ion scheduling device. In an ion scheduling device, the various potentials are such that different ions of different m/z ratios can accumulate within the ion scheduling device at different positions within the device, and can be separately released from the ion scheduling device in an m/z-dependent fashion. An ion scheduling device may for example accumulate up to 10 precursors of different m/z ranges in succession.

An ion scheduling device 750 may be used to provide an additional element of selectivity to mass analysis, or to reduce ion losses due to mass isolation that precedes typical MS/MS analysis, by presenting a narrowed mass range to the filter.

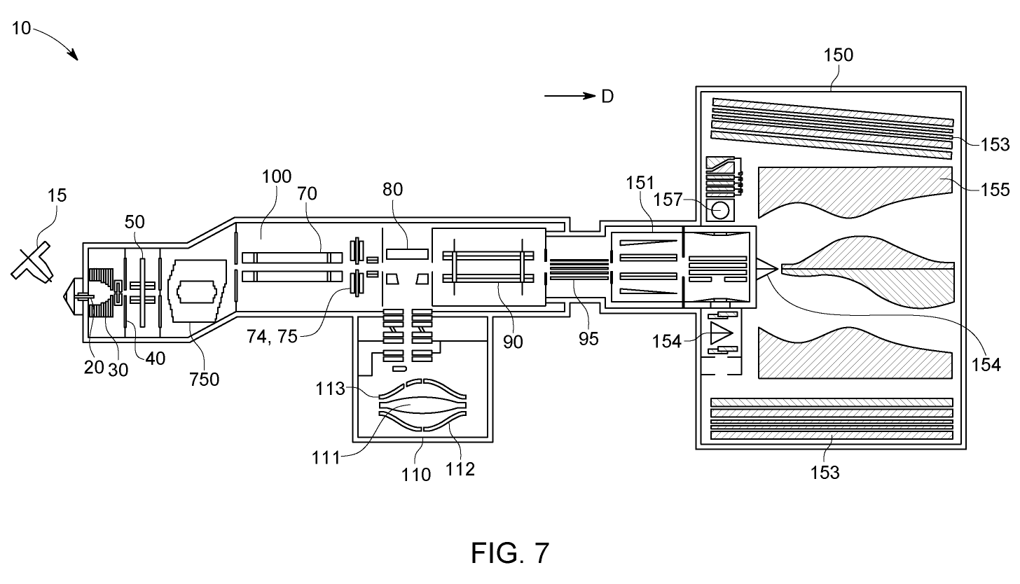

FIG. 7 shows a schematic arrangement of a mass spectrometer that may be operated in accordance with embodiments of the present disclosure wherein the method comprises accumulation of ions in an ion scheduling device 750. The mass spectrometer may be identical to the mass spectrometer of FIG. 1 in all aspects except the inclusion of the ion scheduling device.

The ion scheduling device 750 may be, within the mass spectrometer, upstream of at least one of the ion transfer stages 100. The ion scheduling device 750 may be positioned downstream of the ion source 15 and upstream of the mass analyser 150. The ion scheduling device 750 may be positioned upstream of any or all of quadrupole mass filter 70, a charge detector 75, a curved linear ion trap (C-trap) 80, a collision cell 90, and a multipole ion guide 95. The ion scheduling device 750 may be positioned downstream of any or all of a capillary 20, an ion funnel 30, a calibrant source 40, and a quadrupole pre-filter 50. Within the mass spectrometer, the ion scheduling device 750 may replace the ion guide 60.

In the above-described embodiments, the method may involve carrying out an MS1 scan (e.g. a full mass scan) and then an MS2 scan on narrow mass ranges, or precursors filtered by mass to charge ratio (m/z). In the methods described with reference to FIGS. 4 and 5, the MS2 scan is carried out for each precursor in a list of precursors to be analysed in sequence, with the next precursor in the list of precursors being analysed when the previous scan is completed, until the precursors are exhausted. In embodiments of the method where the ion storage device is a region of an ion scheduling device 750, a plurality of precursors, for example, m precursors, are selected.

For each of the m precursors, the ion current from the precursor list may be calculated based on information from the initial MS1 scan. The desired accumulation time T_{D} for each of the m precursors is determined. The desired accumulation time T_{D} for each of the m precursors may be calculated based on the ion currents for each of the m precursors. Based on the desired accumulation time T_{D}, whether averages are to be taken and how many may be determined for each of the m precursors.

The m precursors may be simultaneously accumulated in the accumulation region of the ion scheduling device 750 for analysis by MS2 scan. The precursors are separately accumulated in the accumulation region of the ion scheduling device 750 separated by m/z range. The ion scheduling device 750 may for example accumulate up to 10 different precursors simultaneously. The ions accumulate for an accumulation time which may be controlled by an ion gate upstream of the ion scheduling device or by gating via the quadrupole pre-filter 50.

Following an accumulation time, the ion scheduling device 750 separately pulse ejects the precursors to be analysed in an MS2 scan. The precursors may be ejected sequentially, for example, according to the m/z ratio ranges of the precursors. For example, ions of the first precursor are ejected and then analysed, and then a second precursor, and so on until the m thprecursor and all the accumulated ions have been ejected from the ion scheduling device 750.

The precursors ejected from the ion scheduling device, after ejection, and prior to analysis, are mass filtered and fragmented in ion transfer stages 100.

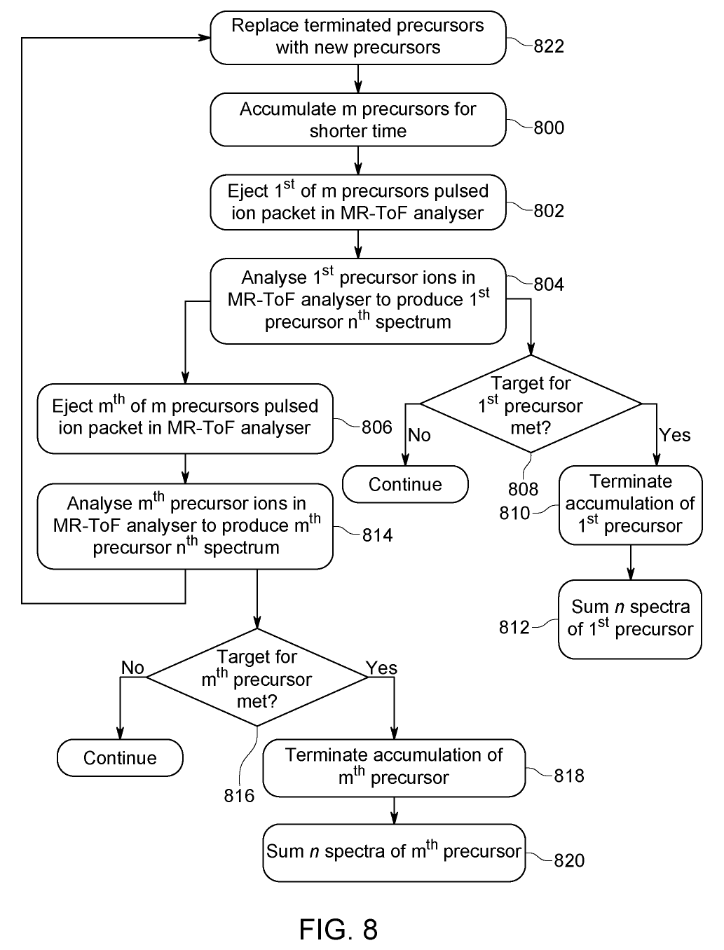

FIG. 8 illustrates a method of dynamic averaging of ion accumulation as applicable to a mass spectrometer as shown in FIG. 7 comprising an ion scheduling device 750. As shown in FIG. 8, m precursors are simultaneously accumulated in the accumulation region of the ion scheduling device 750 (step 800) for a scheduler accumulation time.

The scheduler accumulation time may be equal to the threshold accumulation time T_{T} for the ion storage device, which in this embodiment is the accumulation region of the ion scheduling device 750. The threshold accumulation time T_{T} and each desired accumulation time for each precursor T_{D} may be determined as described above with reference to FIG. 5.

The scheduler accumulation time may be fixed.

A first precursor of the m precursors is pulse ejected from the ion scheduling device 750, may pass through at least some of ion transfer stages 100, and is injected into the downstream mass analyser such as an MR-ToF analyser 150 (step 802). The ion packet of the first precursor are analysed in the MR-ToF analyser 150 and a first spectrum for the first precursor is obtained (step 804). The ion packet of the next precursor is then ejected from the ion scheduling device 750 (step 806) and a first spectrum for the next precursor is obtained (step 814), until all m precursors accumulated in the ion scheduling device 750 have been ejected from the ion scheduling device, injected to the MR-ToF analyser, and analysed. The accumulation and subsequent ejection and analysis of all the ions in the ion scheduling device is a single ion scheduling cycle.

The ion scheduling cycle repeats and m precursors are accumulated in the ion scheduling device 750 for the scheduler accumulation time and then separately ejected and analysed.

Each precursor has a desired accumulation time T_{D} which may be achieved after n ion scheduling cycles.

When the desired accumulation time T_{D} for a precursor is less than or equal to the threshold accumulation time T_{T} for the ion scheduler device, n is 1, in which case, the precursor is analysed in a single ion scheduling cycle and a single spectrum is produced, and there is no averaging or summing of spectra required. The ions are accumulated over the desired accumulation time T_{D}, and, if the scheduler accumulation time is fixed and is more than the desired accumulation time T_{D}, may accumulate for a time longer than the desired accumulation time T_{D}.

When the desired accumulation time T_{D} for a precursor is greater than the threshold accumulation time T_{T}, n is greater than 1 and the precursor is analysed in multiple ion scheduling cycles. In this case, the precursor is analysed n times in n ion scheduling cycles, and n mass spectra are processed into a single mass spectrum.

When the desired accumulation time T_{D} for a precursor is greater than the threshold accumulation time T_{T}, a plurality of n shorter accumulation times are defined. Each shorter accumulation time is shorter than the desired accumulation time T_{D}. The plurality of shorter accumulation times are determined based on the desired accumulation time T_{D} and the threshold accumulation time T_{T}. This comprises determining the number of shorter accumulation times n and the duration of each shorter accumulation time n. The shorter accumulation time may be equal to the scheduler accumulation time, which may be equal to the threshold accumulation time.

The sum of the durations of the n scheduler accumulation times may be greater than, less than or equal to the desired accumulation time T_{D}.

Optionally, sum of the durations of the n shorter accumulation times may be greater than the desired accumulation time T_{D} by no more than 10%. Optionally, sum of the durations of the n shorter accumulation times may be less than the desired accumulation time T_{D} by no more than 10%.

n may be compared to a maximum value of n. The maximum value of n may be selected such that very trace precursors which may have a very long desired accumulation time T_{D} do not dominate instrument time. Accordingly, when n is greater than the maximum value, n may be set to the maximum value, or the instrument may skip over the very trace precursor and move to the next.

If after a number n of ion scheduling cycles, the desired accumulation time T_{D} is met for a particular precursor, for example, for the first precursor, the device may terminate the accumulation of said precursor (step 810, step 818). The n spectra for each precursor are then processed to a single mass spectrum (step 812, step 820). This may be done by summing the n mass spectra or averaging the n mass spectra. The resulting mass spectrum can have improved dynamic range over a mass spectrum taken over a single ion packet accumulated over the original desired accumulation time T_{D}.

In the next ion scheduling cycle, a new precursor is accumulated in place of the terminated precursor (step 822). In this way, different precursors with different desired accumulation times and different values of n can be accumulated in the ion scheduling device and analysed.

Before step 822, a check may be made if there are remaining precursor ions to be analysed. If there are remaining precursor ions to be analysed, they are accumulated in place of any terminated precursor in step 822. If there are no remaining precursor ions to be analysed, the instrument may move on to the next MS1 scan.

The choice and/or order of the precursors to be analysed may be determined and/or optimised by an algorithm which takes into account the m/z ratios of each precursor and that each simultaneously accumulated precursor must be sufficiently separated in m/z ratio for the ion scheduling device to sufficiently separate the different precursors.

In data independent acquisition analysis, a single preprogrammed set of precursors may be accumulated in the ion scheduling device and the ion scheduling cycles may be repeated a fixed number of times before all of the set of precursors are replaced with a new preprogrammed set of precursors.

The method described in accordance with FIG. 8 may be combined with the methods or steps of the methods described with reference of FIGS. 3, 4, and/or 5.

Whereas FIG. 1 depicts specific types of initial mass analyser 110 and downstream mass analyser 150, only one mass analyser is necessary, and other types of mass analyser(s) may be provided.

1. A method of operating an analytical instrument for analysing ions, wherein the analytical instrument comprises an ion storage device, the method comprising:
determining a target accumulation time;
determining whether the target accumulation time is greater than a threshold accumulation time;
when it is determined that the target accumulation time is less than the threshold accumulation time:
accumulating ions in the ion storage device over the target accumulation time; and
injecting the accumulated ions as a pulse for analysis;
when it is determined that the target accumulation time is greater than the threshold accumulation time:
defining a plurality of shorter accumulation times, the shorter accumulation times each being shorter than the target accumulation time, the shorter accumulation times being determined based on the target accumulation time and the threshold accumulation time; and
sequentially for each of the shorter ion accumulation times:
accumulating ions in the ion storage device over the shorter ion accumulation time and injecting the ions accumulated over the shorter ion accumulation time as a pulse for analysis; and
performing analysis of the or each injected pulse.

2. The method of claim 1, wherein the instrument comprises a downstream mass analyser downstream of the ion storage device, and the step of performing analysis of the or each injected pulse comprises analysing the or each pulse using the downstream mass analyser.

3. The method of claim 2, wherein the downstream mass analyser is a time of flight mass analyser, such as a multiple reflection time of flight mass analyser.

4. The method of claim 2, wherein ions are accumulated in the ion storage device during the step of performing analysis of the or each injected pulse.

5. The method of claim 2, wherein the threshold accumulation time is based at least in part on the time needed for a single analysis of a pulse using the downstream mass analyser.

6. The method of claim 1, further comprising separating sample molecules in a liquid chromatograph, wherein the threshold accumulation time is based at least in part on the resolution of the liquid chromatograph.

7. The method of claim 1, wherein:
the analytical instrument comprises an ion source upstream of the ion storage device and one or more ion optical devices arranged between the ion source and the ion storage device; and
the threshold accumulation time is based at least in part on the overhead time for ions to pass through the one or more ion optical devices.

8. The method of claim 1, wherein:
the analytical instrument comprises a downstream mass analyser downstream of the ion storage device and one or more ion optical devices arranged between the ion storage device and the downstream mass analyser; and
the threshold accumulation time is based at least in part on the overhead time for ions to pass through the one or more ion optical devices.

9. The method of claim 1, wherein the threshold accumulation time is based at least in part on a space charge limit of the ion storage device or downstream mass analyser.

10. The method of claim 9 wherein the threshold accumulation time is based at least in part on the ions to be accumulated in the ion storage device.

11. The method of claim 1, wherein the method comprises, when it is determined that the target accumulation time is greater than the threshold accumulation time, taking an average, sum or weighted sum of the results of the step of performing analysis of each injected pulse.

12. The method of claim 1, wherein the method comprises limiting the number of shorter accumulation times based on a predetermined maximum number.

13. The method of claim 1, wherein the plurality of shorter accumulation times are unequal.

14. The method of claim 1, wherein the method comprises, when it is determined that the target accumulation time is greater than the threshold accumulation time, modifying one or more analysis parameter(s) between each injected pulse.

15. The method of claim 1, wherein the ion storage device is a radio frequency (RF) voltage ion storage device, comprising electrodes for extracting ions from the ion storage device by the application of a DC voltage.

16. The method of claim 1, wherein determining a target accumulation time comprises analysing a sample of ions representative of the ions to be accumulated in the ion storage device.

17. The method of claim 16, wherein a second mass analyser is used to analyse the sample of ions to determine the target accumulation time, wherein the second mass analyser is different from the downstream mass analyser.

18. The method of claim 1, wherein the ion storage device is or comprises one or more of: an ion trap; an ion extraction trap; an ion accumulation device; an ion trapping region; an analytical ion trap; an orthogonal accelerator; a fragmentation cell; a reaction cell and/or a collision cell.

19. The method of claim 1 wherein:
the ion storage device is a region of an ion scheduling device;
accumulating ions in the ion storage device comprises accumulating, simultaneously, within the ion storage device, a plurality of precursors separated by a mass to charge ratio; and
injecting the ions accumulated as a pulse for analysis comprises separately and sequentially injecting the ions accumulated of each precursor from the ion storage device for analysis.

20. An analytical instrument for analysing ions, the analytical instrument comprising:
an ion storage device; and
a control system;
wherein the control system is configured to determine a target accumulation time, and to determine whether the target accumulation time is greater than a threshold accumulation time;
wherein the control system is configured to, when it is determined that the target accumulation time is less than the threshold accumulation time:
cause the instrument to accumulate ions in the ion storage device over the target accumulation time; and
cause the instrument to inject the accumulated ions as a pulse for analysis;
wherein the control system is configured to, when it is determined that the target accumulation time is greater than the threshold accumulation time:
define a plurality of shorter accumulation times, the shorter accumulation times each being shorter than the target accumulation time, the shorter accumulation times being determined based on the target accumulation time and the threshold accumulation time; and
cause the instrument to, sequentially for each of the shorter ion accumulation times:
accumulate ions in the ion storage device over the shorter ion accumulation time and inject the ions accumulated over the shorter ion accumulation time as a pulse for analysis; and
wherein the control system is configured to cause the instrument to perform analysis of the or each injected pulse.
